(19) United States
(12) Patent Application Publication
(10) Pub. No.: US 2009/0271698 A1
(43) Pub. Date: Oct. 29, 2009

(54) System reporter-repository auditor

(75) Inventor: Ali Mirza Zamurad, Frisco, TX (US)

Correspondence Address: ALCATEL-LUCENT, C/O GALASSO & ASSOCIATES, LP, P. O. BOX 26503, AUSTIN, TX, 78755-0503, US

(73) Assignee: ALCATEL LUCENT

(21) Appl. No.: 12/148,813

(22) Filed: Apr. 23, 2008

(51) Int. Cl. G06F 17/22

(52) U.S. Cl. 715/234

(57) ABSTRACT

The System Reporter-Repository Auditor is a method for compiling system inventory data in an IPTV solution, including IPTV and database patches, and generating files in editable format. The method involves accumulation of system data in XML and other text format and generation of a configurable file/report from the XML and text files.

### CROSS REFERENCE TO RELATED APPLICATIONS

This United States Non-Provisional Patent Application does not claim priority to any United States Provisional Patent Application or any foreign patent application.

### FIELD OF THE DISCLOSURE

The disclosures made herein relate generally to the electronic data generation and compilation industries. The invention discussed herein is in the general classification of methods for collecting system inventory data in an IPTV solution, including IPTV and database patches, and generating reports in editable format.

### BACKGROUND

Many types of files are shared over the internet for a variety of reasons. It is often advantageous to be able to collect files in one central location that can be accessed by many users. It is also desirable to be able to download files to a workstation in editable format. End users often request that files being sent to them be in a non-static format to permit manipulation of the data within the file for specific uses. Unfortunately, many files currently are not available in non-static format.

HTML (HyperText Markup Language) is often used for web pages, providing a means of describing the structure of text (e.g. links, headings, etc.) in a document. HTML documents use file extension .html or .htm and are delivered like any other computer files.

CHM (Compiled HTML Help) is a proprietary format for online help files. A CHM help file uses a .chm extension. The CHM format uses a set of web pages written in a subset of HTML. CHM files are indexed for reading convenience and utilize a hyperlinked table of contents.

XML (Extensible Markup Language) describes the requirements for creating customizable markup languages. XML allows users to define certain elements and share data across the internet.

WMI (Windows Management Instrumentation) is a set of extensions to the windows driver model. WMI provides an operating system interface that allows various components to provide information and notification. WMI permits scripting languages to control both personal computers and servers.

ADS (Automated Deployment Services) is an element of Microsoft Windows that includes tools for automation. ADS permits installation and editing without administrative input. ADS also allows management of multiple servers.

Internet Protocol Television (IPTV) allows digital television service to be delivered via the internet. IPTV is capable of receiving and displaying a video stream encoded as a series of IP packets. IPTV is a complicated system with a large database and many live subscribers. Periodically, software upgrades may require a change in the baseline data schemas in the form of database patches. The IPTV system also must be checked periodically to validate its integrity through end-to-end health checks.

Visual Studio Tools for Office (VSTO) is a collection of developmental tools, allowing extensions to applications to be written in .NET languages.

An IPTV CHM file displays limited inventory data in static (non-editable) format. FIG. 1 shows the type of inventory data that is displayed by the IPTV CHM file.

Because the CHM file involves statically compiled data, the recipient of the file is not able to change the data in the file and cannot view any IPTV patch information in the file. It is also not possible to change or read/edit the contents of the file with simple automation.

Hence, there is a need in the art for a convenient to use, reliable, and inexpensive method for compiling system inventory data in an IPTV solution, including IPTV and database patches, and generating files containing the data in editable format.

### SUMMARY OF THE DISCLOSURE

The System Reporter-Repository Auditor is a method for compiling system inventory data in an IPTV solution, including IPTV and database patches, and generating files in editable format.

The principal object of this invention is to provide a method for compiling system inventory data in an IPTV solution and generating files in editable format.

Another object of this invention is to provide a method for compiling system inventory data in an IPTV solution that includes IPTV and database patches for end-to-end health checks with the ability to edit.

Another object of this invention is to provide a method for compiling system inventory data in an IPTV solution and generating files in editable format that is relatively inexpensive to implement and maintain.

Another object of this invention is to provide a method for compiling system inventory data in an IPTV solution and generating files in editable format that is customizable and extendable.

Another object of this invention is to provide a method for compiling system inventory data in an IPTV solution and generating files that easily can be edited with formulas and other integration techniques.

Yet another object of this invention is to provide a method for compiling system inventory data in an IPTV solution and generating files in editable format that can be manipulated by the recipient using a variety of tools.

### BRIEF DESCRIPTION OF THE DRAWINGS

FIG. 1A depicts the top portion of an IPTV CHM file displaying the inventory data in static format.

FIG. 1B depicts the bottom portion of an IPTV CHM file displaying the inventory data in static format.

FIG. 2 depicts various servers and workstations implementing the preferred method of the present invention.

FIG. 3A depicts the left portion of a repository auditor report of the preferred embodiment.

FIG. 3B depicts the right portion of a repository auditor report of the preferred embodiment.

### DETAILED DESCRIPTION OF THE DRAWINGS

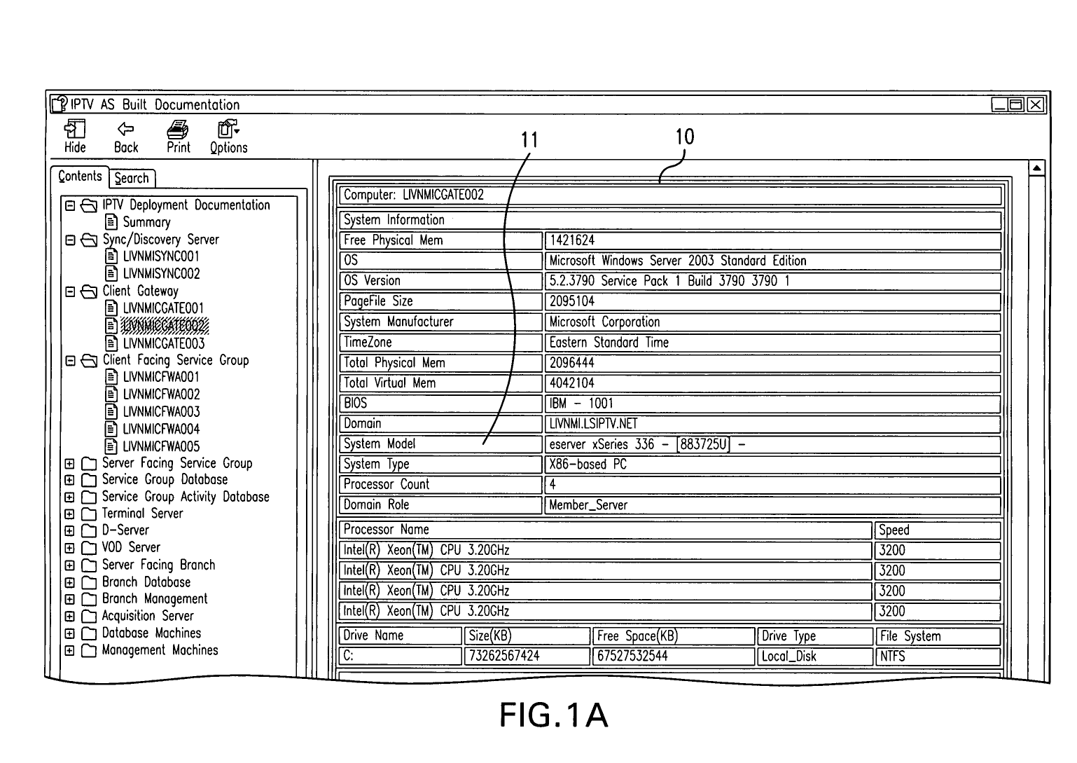

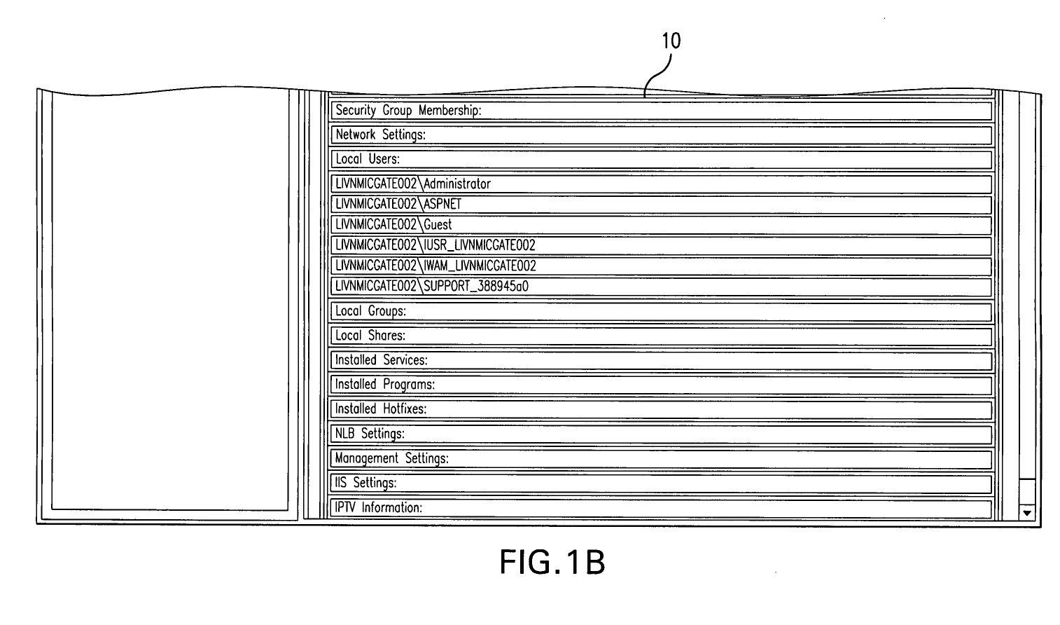

FIG. 1A depicts the top portion of an IPTV CHM file displaying the inventory data in static format. A CHM file may display a variety of data. In the IPTV solution depicted, a CHM file 10 displays system data 11 related to the IPTV servers. The system data 11 is static in nature and cannot be modified with ease.

FIG. 1B depicts the bottom portion of an IPTV CHM file displaying the inventory data in static format. Additional fields of the CHM file 10 can be seen in this figure.

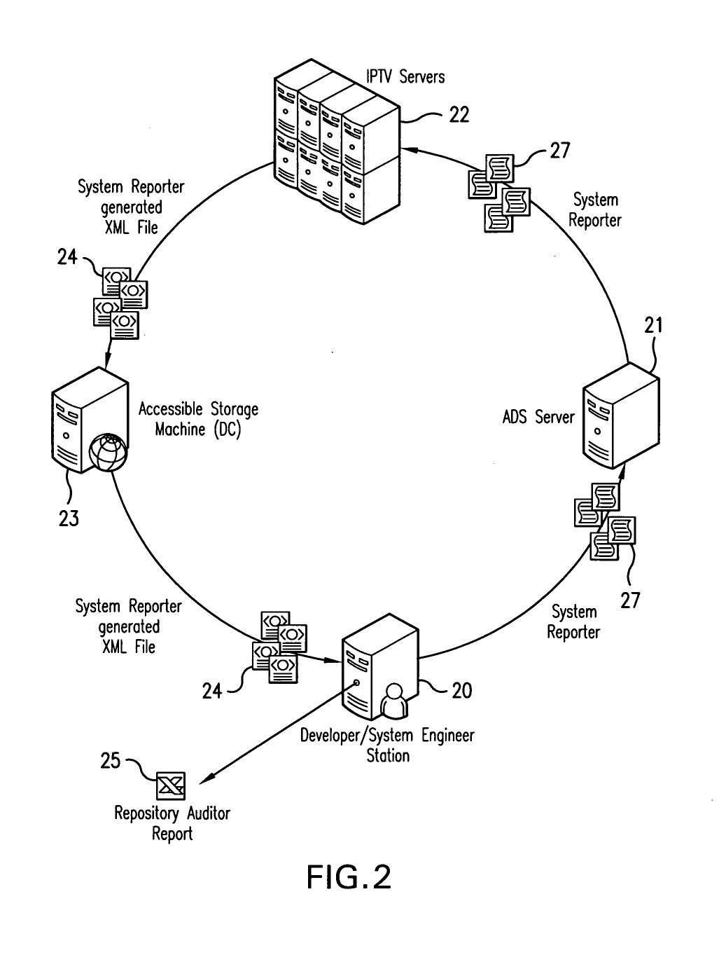

FIG. 2 depicts various servers and workstations implementing the preferred method of the present invention. The method begins at Developer/System Engineer Station 20. Developer/System Engineer Station 20 can be a computer connected to a network or simply a location containing a copy of files such as a flush drive or some other medium capable of transporting files to Automated Deployment Service (ADS) server 21. In this embodiment, a set of files including configuration files and scripts (files 27) are sent from the Developer/System Engineer Station 20 to the ADS server 21. The files 27 may be of many types, including, but not limited to, executable, batch, XML, ADS Sequences (XML) or SQL scripts.

When the files 27 arrive at the ADS server 21, they can be moved to and executed by any number of IPTV servers as necessary. The ADS server 21 uses ADS scripting to port the incoming files 27 on all servers where the data needs to be collected, including the IPTV servers 22. The ADS server 21 has the ability to move and execute files over the network. The files 27 post to the IPTV servers 22 where a system reporter can be executed.

The system reporter installed on the IPTV servers 22 generates XML files 24 from the files 27. The XML files 24 carry system data which can be fetched via WMI calls and registry fetching. The system reporter can also generate TXT files carrying other types of data. On database machines, database patches also can be collected in an XML file.

The XML files 24 from the IPTV servers 22 are then collected into one shared location, Accessible Storage Machine 23. The XML files 24 are then sent from Accessible Storage Machine 23 to Developer/System Engineer Station 20 to utilize the repository auditor installed on Developer/System Engineer Station 20 to generate a repository auditor report 25. This repository auditor report 25 is in the form of an Excel file, in the preferred embodiment, and contains all of the information from the XML files 24 that were collected.

The repository auditor within the Developer/System Engineer Station 20 takes the incoming XML files 24 and any TXT files and generates a repository auditor report 25 for the related and collected system data, IPTV server patches, database patches and other information about network configurations and drivers.

The Developer/System Engineer Station 20 utilizes VST0 2005 to accumulate system data through WMI calls, registry fetching, and database queries. The Developer/System Engineer Station 20 collects the XML files 24 having configuration files that are all customizable and extendable to allow a user to obtain data.

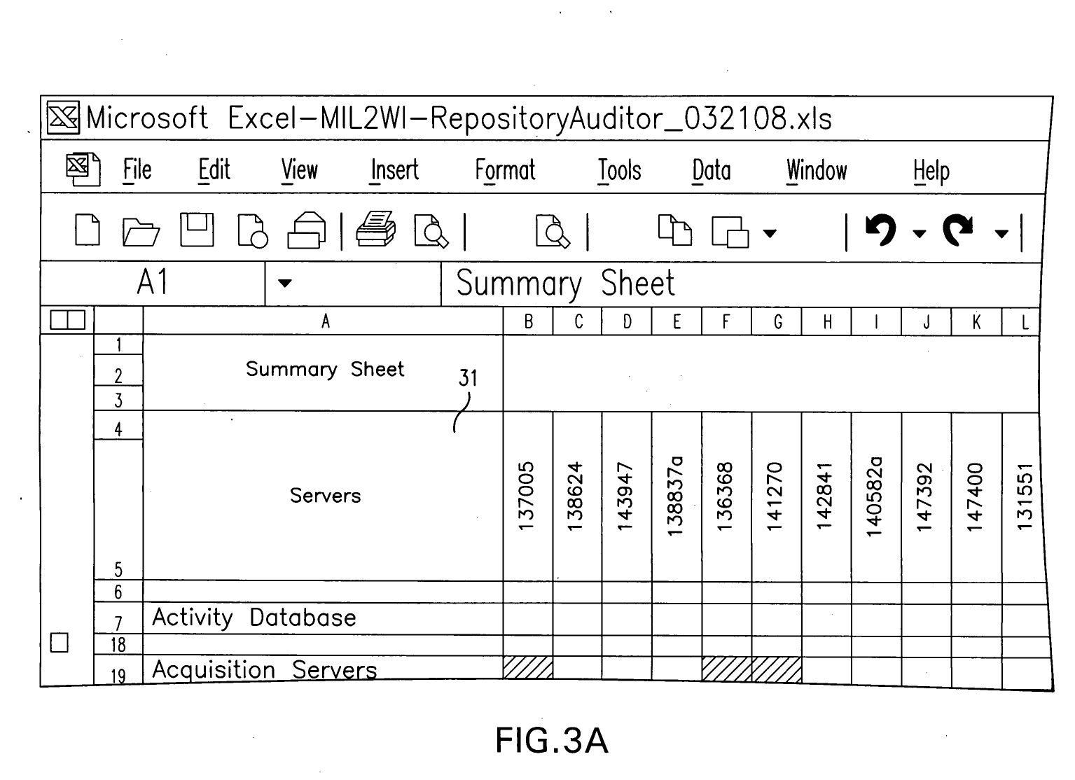

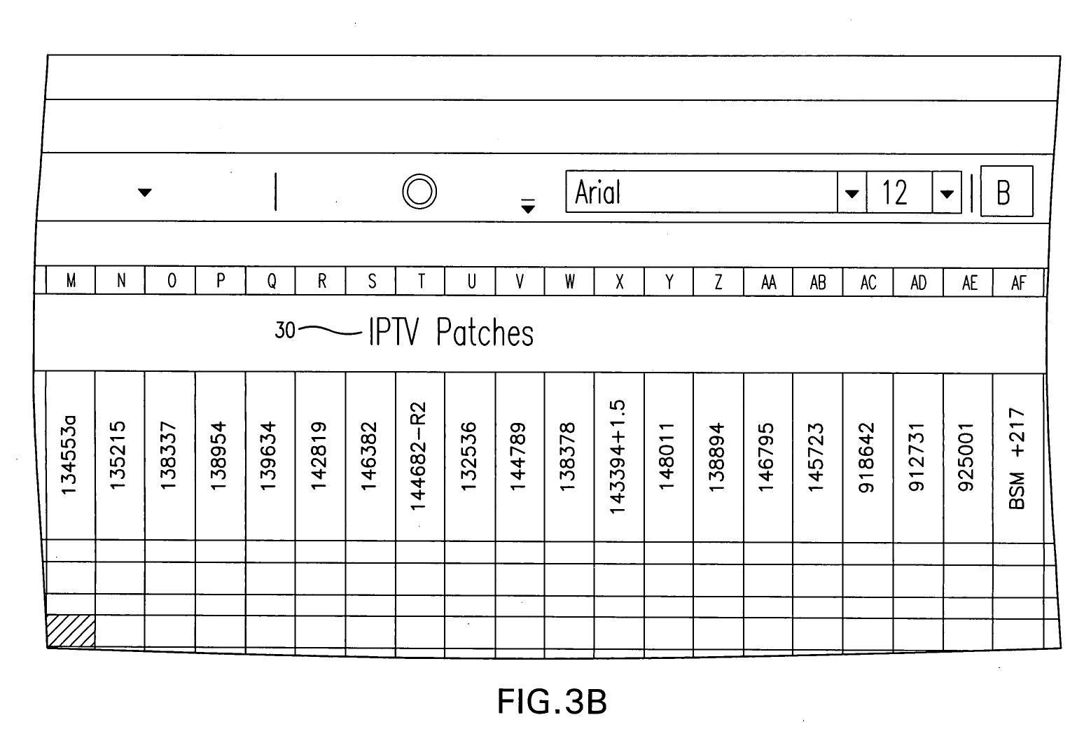

FIG. 3A depicts the left portion of a repository auditor report of the preferred embodiment. The repository auditor report 25 is in the form of an ordinary Excel file that can be customized in any way appropriate for a specific customer. The repository auditor report 25 contains all the data collected in the XML files and TXT files. The repository auditor report 25 also displays the IPTV patches information 30 and servers information 31 in a digestible manner. If there are problems with the health of the deployed system, this is also indicated in the repository auditor report 25.

In this preferred embodiment, the health indicators 32 are color coded to indicate if there are problems associated with any particular group. For example, a green health indicator indicates that everything is proper in a given group whereas a red health indicator indicates that there is some issue in that particular group.

FIG. 3B depicts the right portion of a repository auditor report of the preferred embodiment. Additional IPTV patches information 30 is displayed in this portion of the repository auditor report 25.

Alternatively, the XML files 24 can also be used to transport data via web services or simply to create HTML web files instead of generating a repository auditor report.

It is contemplated that the method described herein can be implemented as software, including a computer-readable medium having program instructions executing on a computer, hardware, firmware, or a combination thereof. The method described herein also may be implemented in various combinations on hardware and/or software.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A method for collecting system inventory data comprising the steps of:
(a) transporting a set of files from a system engineer station to an ADS server;
(b) sending the set of files from the ADS server to an IPTV server;
(c) generating a set of XML files at the IPTV server using a system reporter and the set of files;
(d) collecting the set of XML files from the IPTV server in an accessible storage machine;
(e) sending the set of XML files from the accessible storage machine to the system engineer station; and
(f) generating a repository auditor report at the system engineer station using a repository auditor and the set of XML files.

2. The method of claim 1 further comprising the steps of:
(a) generating a set of TXT files at the IPTV server using the system reporter and the set of files;
(b) collecting the set of TXT files from the IPTV server in the accessible storage machine;
(c) sending the set of TXT files from the accessible storage machine to the system engineer station; and
(d) using the repository auditor to include data from the set of TXT files in the repository auditor report.

3. The method of claim 1 wherein the set of files are executable.

4. The method of claim 1 wherein the set of files are batch.

5. The method of claim 1 wherein the set of files are XML.

6. The method of claim 1 wherein the set of files includes SQL scripts.

7. A method for collecting system inventory data comprising the steps of:
(a) sending a set of files from a system engineer station to an ADS server;
(b) sending the set of files from the ADS server to an IPTV server;
(c) generating a set of XML files at the IPTV server from the set of files;
(d) collecting the set of XML files at an accessible storage machine;
(e) sending the set of XML files from the accessible storage machine to the system engineer station; and
(f) generating a repository auditor report from the set of XML files.

8. The method of claim 7 further comprising the step of:
generating a set of TXT files at the IPTV server from the set of files.

9. The method of claim 8 further comprising the step of:
collecting the set of TXT files at the accessible storage machine.

10. The method of claim 9 further comprising the step of:
sending the set of TXT files from the accessible storage machine to the system engineer station.

11. The method of claim 10 further comprising the step of:
including data from the set of TXT files in the repository auditor report.

12. A method for collecting system inventory data comprising the steps of:
(a) generating an XML file from a file; and
(b) generating a repository auditor report in a configurable form from the XML file.

13. The method of claim 12 wherein the step of generating an XML file from a file is done at an IPTV server using a system reporter.

14. The method of claim 13 wherein the step of generating a repository auditor report is done at a system engineer station using a repository auditor.
